(19) United States
(12) Patent Application Publication
(10) Pub. No.: US 2026/0359963 A1
(43) Pub. Date: Nov. 12, 2026

(54) VEHICLE SIDE MIRROR SYSTEM FOR RECOGNIZING VEHICLE DAMAGE SCENE

(71) Applicant: Dong Il KIM, Wonju-si (KR)

(72) Inventor: Dong Il KIM, Wonju-si (KR)

(21) Appl. No.: 19/245,513

(22) Filed: Jun. 23, 2025

(30) Foreign Application Priority Data
May 8, 2025 (KR) 10-2025-0059485

(51) Int. Cl. G06T 7/00; B60R 1/072; B60R 1/12; B60R 1/22; B60R 11/04

(52) U.S. Cl. CPC G06T 7/0004; B60R 1/072; B60R 1/12; B60R 1/22; B60R 11/04; B60R 2001/1253; G06T 2207/20081; G06T 2207/20084; G06T 2207/30252

(57) ABSTRACT

Proposed is a vehicle side mirror system for capturing scenes using a camera attached to the side mirror, particularly for recording incidents in which the vehicle is damaged when parked. The system includes a side mirror unit attached to both sides of a front surface of a driver's vehicle, a camera unit for recording a front of the vehicle when driving and for recording a side surface of the vehicle when parked, a bracket unit for supporting the camera unit and for fastening the camera unit to the side mirror unit, a display unit for displaying a video recorded by the camera unit, and a control processor for communicating with the camera unit, wherein the control processor includes a storage unit for storing the video recorded by the camera unit and a vehicle damage analyzer for determining whether the vehicle is damaged by analyzing the recorded video.

### CROSS REFERENCE TO RELATED APPLICATION

The present application claims priority to Korean Patent Application No. 10-2025-0059485, filed on May 8, 2025, the entire contents of which are incorporated herein for all purposes by this reference.

### BACKGROUND

### Technical Field

The present disclosure relates to a vehicle side mirror system for capturing scenes using a camera attached to the side mirror, particularly for recording incidents in which the vehicle is damaged when parked.

### Description of the Related Art

Unless otherwise indicated in the present specification, the materials described in this section are not prior art to the claims of this application, and being included in this section does not mean that it is acknowledged as a prior art.

A dashcam is a device that is mounted on a vehicle and automatically records videos, voices, and driving information while driving. Cameras are mainly installed at the front and rear to record the driving situation in real time, and when events such as incidents, sudden stops, and sudden departures occur, the relevant scene is automatically stored. The stored data is utilized as important evidence in the event of an incident for analyzing the cause, determining responsibility, and processing insurance.

Some products record the vehicle's location and speed information via GPS, and have a function to detect an impact and start recording even when parked. Recently, various functions such as high-definition video recording, night infrared recording, cloud storage, voice guidance, and smartphone linkage have been installed to improve driver convenience and safety.

Conventional dashcams have the function to detect an impact and start recording when parked, but there is a problem of not working for small impact damage to the vehicle (e.g., scratches by sharp objects, etc.).

### SUMMARY

In order to solve the problem mentioned above, a vehicle side mirror system according to an exemplary embodiment of the present disclosure provides a vehicle side mirror system for recognizing scenes of damage to a vehicle and is capable of storing videos related to vehicle damage when actual damage occurs to the vehicle when parked.

A vehicle side mirror system according to an exemplary embodiment of the present disclosure includes a side mirror unit attached to both sides of a front surface of a driver's vehicle, a camera unit mounted on the side mirror unit for recording a front of the vehicle when driving and for recording a side surface of the vehicle when parked, a bracket unit for supporting the camera unit and for fastening the camera unit to the side mirror unit, a display unit for displaying a video recorded by the camera unit, and a control processor for communicating with the camera unit, wherein the control processor includes a storage unit for storing the video recorded by the camera unit and a vehicle damage analyzer for determining whether the vehicle is damaged by analyzing the video recorded by the camera unit.

As an exemplary embodiment, the bracket unit may include a tilting function capable of adjusting an angle of the camera unit so that the camera unit can record a rear side surface of the vehicle when parked.

As an exemplary embodiment, the vehicle damage analyzer may capture and store the scene when detecting an object moving at or below a certain distance from the side surface of the vehicle.

As an exemplary embodiment, the control processor may further include a communication module capable of communicating with a user terminal, wherein the vehicle damage analyzer may transmit the captured and stored video to the user terminal through the communication module.

As an exemplary embodiment, the control processor may further include a deep learning-based artificial intelligence module, wherein the artificial intelligence module may derive a first feature point by learning on the basis of images of people, animals, and other objects, derives a second feature point in the recorded video for an object moving at or below a certain distance from the side surface of the vehicle, and specifies what the object is by matching the first feature point and the second feature point.

The vehicle side mirror system according to an exemplary embodiment of the present disclosure enables identifying the cause of damage to a vehicle when parked and utilizes the stored images in order to respond to incidents by capturing and storing videos not only for impact detection but also for low-impact damage to the vehicle.

In addition, the vehicle side mirror system according to an exemplary embodiment of the present disclosure can enable a user to respond to incidents immediately after the vehicle is damaged by recording when a vehicle is damaged and transmitting the stored images to a user terminal.

The effects of the present disclosure are not limited to the effects mentioned above, and should be understood to include all effects that can be inferred from the detailed description of the present disclosure or the composition of the present disclosure described in the claims of the patent.

### BRIEF DESCRIPTION OF THE DRAWINGS

FIG. 1 is a view showing a use state of a vehicle side mirror system when a vehicle is driving according to an exemplary embodiment of the present disclosure.

FIG. 2 is a view showing a use state of a vehicle side mirror system when a vehicle is parked according to an exemplary embodiment of the present disclosure.

FIG. 3 is an exemplary view showing that a camera unit of a vehicle side mirror system is mounted on a side mirror unit by a bracket unit according to an exemplary embodiment of the present disclosure.

FIG. 4 is a configuration diagram of a control processor of a vehicle side mirror system according to an exemplary embodiment of the present disclosure.

### DETAILED DESCRIPTION OF THE DISCLOSURE

Hereinafter, exemplary embodiments disclosed in the present specification will be described in detail with reference to the accompanying drawings, but the same or similar components will be assigned with the same reference numbers regardless of the drawing codes, and redundant descriptions thereof will be omitted. The suffixes “module” and “unit” to components used in the following description are given or used interchangeably only for the convenience of writing the specification, and do not in themselves have meanings or roles distinct from each other. In addition, in describing an exemplary embodiment disclosed in the present specification, the detailed description thereof will be omitted when it is determined that a detailed description of the related known technology may obscure the gist of an exemplary embodiment disclosed in the present specification. In addition, the accompanying drawings are only intended to make it easier to understand an exemplary embodiment disclosed in the present specification, and the technical ideas disclosed in the present specification are not limited by the accompanying drawings, and should be understood to include all modifications, equivalents or substitutes included in the spirit and technical scope of the present disclosure.

Terms including ordinal numbers, such as first and second, may be used to describe various components, but the components mentioned above are not limited by the terms mentioned above. The terms are used only for the purpose of distinguishing one component from another component.

In this application, it should be understood that the terms “include” or “have” are intended to specify the existence of features, numbers, steps, operations, components, parts, or combinations thereof described in the specification, and do not exclude the existence or addition of one or more other features, numbers, steps, operations, components, parts, or combinations thereof in advance.

Hereinafter, a vehicle side mirror system according to an exemplary embodiment of the present disclosure will be described in detail with reference to the drawings.

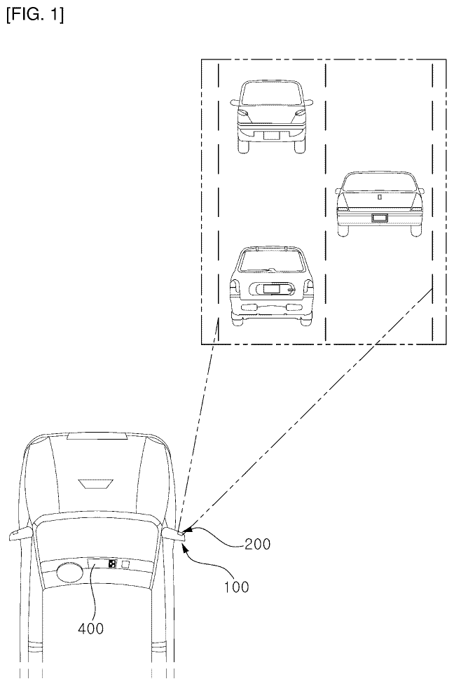

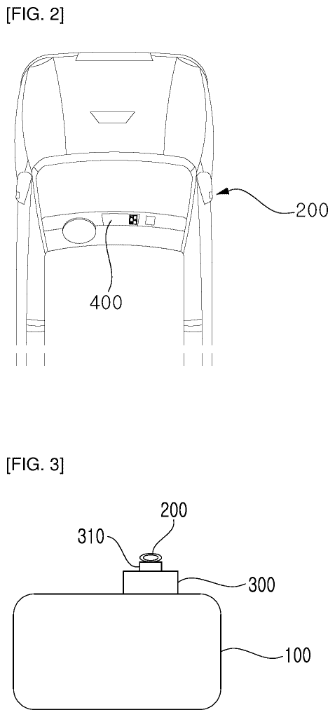

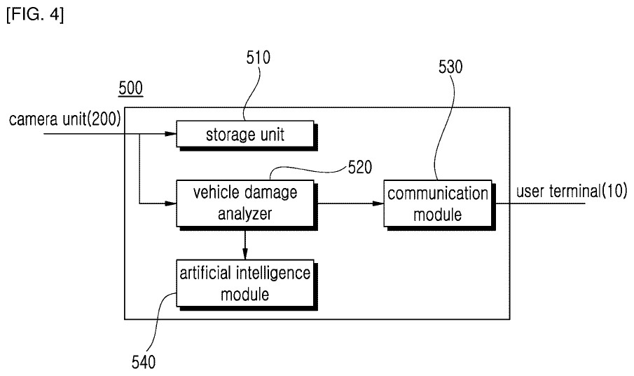

FIG. 1 is a view showing a use state of a vehicle side mirror system when a vehicle is driving according to an exemplary embodiment of the present disclosure, FIG. 2 is a view showing a use state of a vehicle side mirror system when a vehicle is parked according to an exemplary embodiment of the present disclosure, FIG. 3 is an exemplary view showing that a camera unit 200 of a vehicle side mirror system is mounted on a side mirror unit 100 by a bracket unit 300 according to an exemplary embodiment of the present disclosure, and FIG. 4 is a configuration diagram of a control processor 500 of a vehicle side mirror system according to an exemplary embodiment of the present disclosure. Referring to FIGS. 1 to 4, the vehicle side mirror system according to an exemplary embodiment of the present disclosure may include a side mirror unit 100, a camera unit 200, a bracket unit 300, a display unit 400, and a control processor 500.

The side mirror unit 100 may include two side mirrors attached to both sides of the front surface of the driver's vehicle. Herein, the side mirror may be general side mirrors attached to both sides of the vehicle so that the driver can see the rear when driving. The side mirror unit 100 may be automatically folded when the door of the vehicle is locked when parked.

The camera unit 200 may be a type of camera capable of recording the front of the vehicle when driving and recording the side surface of the vehicle when parked. The camera unit 200 may include a wired communication module, and may transmit the recorded videos to the display unit 400 and the control processor 500 to be described later through the wired communication module. Referring to FIG. 3, the camera unit 200 may be mounted on an upper end of the side mirror unit 100 by a bracket unit 300 to be described later.

The bracket unit 300 may function to support the camera unit 200 and to fasten the camera unit 200 to the side mirror unit 100. Referring to FIG. 3, the bracket unit 300 may be mounted on the side mirror unit 100 by way of screws or clips, but this may be merely exemplary and not be limited thereto. A rotation motor may be included in the bracket unit 300, and a support member 310 connected to a central axis of the rotation motor may support the camera unit 200 so that the camera unit 200 can be fastened to the side mirror unit 100. The rotation motor may provide a tilting function for adjusting an angle of the camera unit 200. The camera unit 200 may be mounted on the support member 310 in a screw manner, but this may be merely exemplary and not be limited thereto.

As shown in FIG. 1, while the vehicle is driving, the rotation motor may be operated such that the camera unit 200 can record the front of the vehicle in a state where the side mirror unit 100 is unfolded. As shown in FIG. 2, when the vehicle is parked, the rotation motor may be operated such that the camera unit 200 can record the rear side surface of the vehicle in a state where the side mirror unit 100 is folded. In other words, the difference in the angle of the rotation motor when the vehicle is driving and when the vehicle is parked may be approximately 90°.

When the door of the vehicle is locked when the vehicle is parked, the side mirror unit 100 may be automatically folded, and at the same time, the rotation motor may be configured to automatically rotate about 90°toward the door of the vehicle. For this reason, the camera unit 200 can record the rear side surface of the vehicle when the vehicle is parked. For example, the rotation motor may be connected to and controlled by a controller area network (CAN), which is a control network of the vehicle. For example, a rotation angle when the vehicle is driving and a rotation angle when the vehicle is parked may be set through the control processor 500 to be described later.

The display unit 400 may function to transfer and display the videos recorded by the camera unit 200 so that the driver can see the videos. The display unit 400 may be a screen of an infotainment system installed in front of a driver inside the vehicle.

Referring to FIG. 1, the camera unit 200 may record the front of the vehicle while the vehicle is driving, and the driver may observe not only the next lane of the driving lane but also the front traffic situation of the next lane through the display unit 400, thereby efficiently determining whether to change the lane. In particular, it is possible for the driver to observe not only the next lane of the passenger seat where it is difficult to secure the driver's view but also the front traffic situation of the next lane, thereby more efficiently determining whether to change the lane to the next lane of the passenger seat.

The control processor 500 may be a computing device or a processor board including at least one central process unit (CPU) and at least one memory device. The control processor 500 may function to receive and store the videos recorded by the camera unit 200 while the vehicle is driving, and may function to analyze the recorded videos and to determine whether the vehicle is damaged when parked. Referring to FIG. 4, the control processor 500 may include a storage unit 510 and a vehicle damage analyzer 520.

The storage unit 510 may function to receive and store the videos recorded by the camera unit 200 while the vehicle is driving. Of course, when the vehicle is determined to be damaged by the vehicle damage analyzer 520 to be described later, the storage unit 510 may function to store the corresponding video. When the vehicle is determined to be damaged by the vehicle damage analyzer 520, it is preferable to store the corresponding video in a separate directory different from the one where the videos are stored while driving. When storing the videos, the storage unit 510 may store the videos in the form of metadata by including the time and location where the camera unit 200 records the videos.

The vehicle damage analyzer 520 may function to receive the videos recorded by the camera unit 200 when the vehicle is parked, and to determine whether the vehicle is damaged. When an object moving within a certain distance from the side surface of the vehicle is captured in the received videos, the vehicle damage analyzer 520 may capture an image of the scene and transmit the same to the storage unit 510 described above, thereby storing the image.

The vehicle damage analyzer 520 may set an area less than or equal to a certain distance from the side surface of the vehicle in the coordinate system of the camera unit 200. Herein, the certain distance may be 30 cm, 20 cm, or 10 cm from the side surface of the vehicle, but may not be limited thereto. The vehicle damage analyzer 520 may detect a moving object when there is a change in the area less than or equal to a certain distance from the side surface of the vehicle within the before and after frames of the video transmitted from the camera unit 200.

A method of setting an area less than or equal to a certain distance from the side surface of the vehicle by the vehicle damage analyzer 520 may be as follows. (A) An object may be placed at a point corresponding to a certain distance (e.g., 20 cm) from the side surface of the vehicle in a state where the camera unit 200 is in operation when the vehicle is parked. (B) The vehicle damage analyzer 520 may store coordinates for pixels of the corresponding object. By repeating the processes of (A) and (B) described above, the vehicle damage analyzer 520 may obtain coordinates for pixels of a plurality of points corresponding to the certain distance from the side surface of the vehicle, and, by utilizing this, may set an area less than or equal to the certain distance from the side surface of the vehicle.

In addition, the vehicle damage analyzer 520 may determine that the vehicle is damaged when there is a change in the side surface of the vehicle within the before and after frames of the video transmitted from the camera unit 200 after detecting a moving object. That is, the vehicle damage analyzer 520 may determine that there is no damage to the vehicle when there is no change in the side surface of the vehicle within the before and after frames of the video after detecting the moving object, and determine that there is damage to the vehicle when there is a change in the side surface of the vehicle.

As an exemplary embodiment, the control processor 500 may further include a communication module 530 capable of communicating with the user terminal 10. Herein, the communication module 530 may be a communication modem capable of connecting to a mobile communication network of 2G, 3G, 4G, 5G, and 6G, which are wireless communication networks. Herein, the user terminal 10 may be a portable terminal such as a smartphone, a tablet PC, and the like capable of connecting to a mobile communication network of 2G, 3G, 4G, 5G, and 6G, which are wireless communication networks.

When detecting a moving object within a certain distance from the side surface of the vehicle, the vehicle damage analyzer 520 may capture the scene and transmit the stored image to the user terminal 10 via the communication module 530. For this reason, there are advantages in that the user can be aware of the fact immediately after the vehicle is damaged and can immediately respond to the incident.

As an exemplary embodiment, the control processor 500 may further include a deep learning-based artificial intelligence module 540. The artificial neural network model used in the artificial intelligence module 540 of the present disclosure may be an artificial neural network (ANN), a recurrent neural network (RNN), a convolution neural network (CNN), a long short-term memory (LSTM), or a combination thereof. However, the present disclosure is not limited thereto.

ANN may be a basic artificial neural network consisting of a layer of neurons connected between inputs and outputs, and may learn features from input data, on the basis of which a task such as classification is performed, thereby learning complex nonlinear relationships. Since the order or temporal dependence between input data is not considered, there may be a limit to data processing such as time series.

RNN may be a neural network with a recurrent structure that receives and outputs the previous state of itself. It is possible to utilize past information by transferring information from the previous time step to the current time step, so RNN may be suitable for problems in which the order or temporal dependence between inputs should be reflected, such as time series data.

CNN may be a neural network that extracts image features by applying a convolutional kernel to the input data, and summarizes the extracted image features through multiple neural networks to be used as an output. CNN may be mainly used for image processing, and may have the characteristics of identifying spatial structures through operations such as convolution and pooling, and making accurate predictions by utilizing image features.

LSTM may be a neural network structured with a cell state added to the hidden layer of an RNN. LSTM may emerge to solve the problem that when the distance between the relevant information of the RNN and the point where the information is used is far, the gradient gradually decreases during backpropagation and the learning ability is greatly reduced.

The artificial intelligence module 540 may derive a first feature point by learning images of people, animals, and other objects. The artificial intelligence module 540 may derive a second feature point for an object moving in an area less than or equal to a certain distance from the side surface of the vehicle in the videos recorded by the camera unit 200. The artificial intelligence module 540 may set a region of interest (ROI) including an object moving in the area less than or equal to a certain distance from the side surface of the vehicle in the videos for the efficiency of image processing in the video. The artificial intelligence module 540 may specify whether the moving object in the video is a human, an animal, or just an object by matching the first feature point and the second feature point through the feature point matching.

When the vehicle damage analyzer 520 detects an object moving in an area less than or equal to a certain distance from the side surface of the vehicle, and captures the scene and transmits the stored image to the user terminal 10 via the communication module 530, the vehicle damage analyzer 520 can transmit the captured and stored image including characters indicating the type specified by the artificial intelligence module 540 to the user terminal 10. Thus, the user can better understand the cause of the vehicle damage, thereby allowing the user to respond to the incident more efficiently.

The disclosed content may be only an example, and the scope of protection of the disclosed content may not be limited to the specific exemplary embodiment described above since various modifications and implementations can be made by a person skilled in the art without departing from the gist of the claims claimed in the patent.

The present disclosure relates to a technology for obtaining videos of a vehicle's surroundings while the car is driving or parked, and has industrial applicability in the automotive industry.

What is claimed is:

1. A vehicle side mirror system, the system comprising:
a side mirror unit attached to both sides of a front surface of a driver's vehicle;
a camera unit mounted on the side mirror unit for recording a front of the vehicle when driving and for recording a side surface of the vehicle when parked;
a bracket unit for supporting the camera unit and for fastening the camera unit to the side mirror unit;
a display unit for displaying a video recorded by the camera unit; and
a control processor for communicating with the camera unit,
wherein the control processor comprises:
a storage unit for storing the video recorded by the camera unit; and
a vehicle damage analyzer for determining whether the vehicle is damaged by analyzing the video recorded by the camera unit.

2. The system of claim 1, wherein the bracket unit comprises a tilting function capable of adjusting an angle of the camera unit so that the camera unit can record a rear side surface of the vehicle when parked.

3. The system of claim 1, wherein when detecting an object moving at or below a certain distance from the side surface of the vehicle, the vehicle damage analyzer captures and stores the scene.

4. The system of claim 3, wherein the control processor further comprises:
a communication module capable of communicating with a user terminal,
wherein the vehicle damage analyzer transmits the captured and stored video to the user terminal through the communication module.

5. The system of claim 1, wherein the control processor further comprises:
a deep learning-based artificial intelligence module,
wherein the artificial intelligence module derives a first feature point by learning on the basis of images of people, animals, and other objects,
derives a second feature point in the recorded video for an object moving at or below a certain distance from the side surface of the vehicle, and
specifies what the object is by matching the first feature point and the second feature point.
